(19) United States
(12) Patent Application Publication
(10) Pub. No.: US 2010/0120518 A1
(43) Pub. Date: May 13, 2010

(54) Animated gaming machine tower light

(76) Inventors: Milo Borissov, Sharjah (AE); Rossi McKee, Sofia (BG); Dimityr Dimitrov, Sofia (BG)

Correspondence Address: WEIDE & MILLER, LTD., 7251 W. LAKE MEAD BLVD., SUITE 530, LAS VEGAS, NV, 89128, US

(21) Appl. No.: 12/291,825

(22) Filed: Nov. 12, 2008

(51) Int. Cl. A63F 13/00; F21V 33/00

(52) U.S. Cl. 463/25; 362/234

(57) ABSTRACT

A tower light for a gaming machine comprises a plurality of printed circuit boards. A plurality of individually controllable LEDs are associated with each circuit board, the LEDs located at a periphery of each circuit board and configured to emit light outwardly from its associated circuit board. The plurality of printed of circuit boards are stacked in a vertically and oriented so that the LEDs associated therewith are arranged into a matrix of columns and rows. The printed circuit boards are located in globe portion of a housing of the tower light. The LED matrix is capable of generating animation and information such as text and numbers.

### FIELD OF THE INVENTION

The present invention relates to gaming machines, and particularly to tower lights for such machines.

### BACKGROUND OF THE INVENTION

Gaming machine manufacturers continually seek to improve gaming machines to make them more user friendly and to entice players to play them. Gaming machine manufacturers have thus configured gaming machines with sound systems, player features such as cup holders, and a variety of other features. However, there remains a need for further improvements to gaming machines to make them more exciting.

### SUMMARY OF THE INVENTION

The invention is a tower light, such as for a wagering gaming machine.

In one embodiment, the tower light comprises a plurality of lamp mounts. In a preferred embodiment, the lamp mounts comprise generally planar printed circuit boards.

A plurality of individually controllable LEDs are associated with each circuit board. The LEDs are located at a periphery of each circuit board and configured to emit light outwardly from its associated circuit board. The LEDs are spaced around the periphery of the circuit board. In embodiment, the circuit boards are circular in shape, so that the LEDs extend 360 degrees around the circuit boards. The LEDs are preferably configured to emit light in two or more colors.

The plurality of printed of circuit boards are stacked in a vertically. The circuit boards are oriented so that the LEDs associated therewith are aligned into vertical columns. The arrangement of the LEDs into rows (around the lamp mounts) and in vertical columns creates a square LED matrix.

The tower light further comprises a housing. In one embodiment, the housing comprises a base, a globe and a cap. The lamp mounts and their associated LEDs are located in the globe.

The tower light may be connected to via a communication link to a controller, such as a gaming machine controller, and a power source. The tower light may be controlled so that the LED matrix is capable of generating animation and information such as text and numbers. This information may be useful to the operator of a gaming machine and/or be provided to player, such as to entice a player to play the gaming machine or to provide a player of the gaming machine information during game play.

Further objects, features, and advantages of the present invention over the prior art will become apparent from the detailed description which follows, when considered with the figures provided herein.

### DESCRIPTION OF THE DRAWINGS

FIG. 1 illustrates a gaming machine having a tower light in accordance with the invention;

FIG. 2 is an exploded view of a tower light in accordance with the invention; and

FIG. 3 illustrates in further detail a plurality of printed circuit boards of a tower light of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises a tower light for a gaming machine. Such a light may be located at a top of a gaming machine and be used to provide information, such as gaming machine condition information to an operator of the machine, and gaming machine attract information to a player.

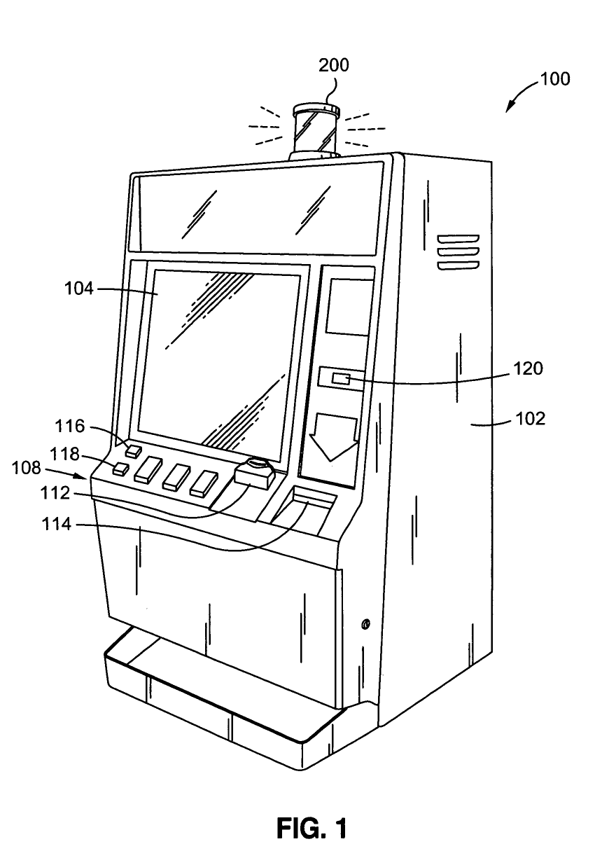

FIG. 1 illustrates one embodiment of a gaming machine or device 100 to which a tower light of the invention has applicability. As illustrated, the gaming machine 100 may be positioned on a support stand for convenient access by a player, but it may be mounted in a variety of manners. The gaming machine 100 might be located in various environments, such as a casino. Preferably, the gaming machine 100 is a wager-based gaming machine configured to present one or more games to a player which offer the possibility of an award of winnings.

In one embodiment, the gaming machine 100 defines a generally enclosed interior space for housing one or more components. As illustrated, the gaming machine 100 generally comprises a housing or cabinet 102 for supporting and/or enclosing various components required for operation of the gaming machine. In the embodiment illustrated, the housing 102 includes a door located at a front thereof, the door capable of being moved between an open position which allows access to the interior, and a closed position in which access to the interior is generally prevented. The configuration of the gaming machine 100 may vary. In the embodiment illustrated, the gaming machine 100 has an “upright” configuration. However, the gaming machine 100 could have other configurations, shapes or dimensions (such as being of a “slant”-type or other configuration as is well known to those of skill in the art).

The gaming machine 100 preferably includes at least one display device 104 configured to display game information. The display device 104 may be a mechanical, electro-mechanical or electronic display, such as one or more rotating reels, a video display or the like. When the display device 104 is an electronic video display, it may comprise a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 104 may be capable of projecting or displaying a wide variety of information, including images, symbols and other indicia or information associated with game play, game promotion or other events.

The gaming machine 100 may be configured to present a wide variety of games. These may include video poker games, slot-type games, blackjack, bingo and bingo-based games, and other games now known or later developed. In one embodiment, certain game outcomes may be designated as winning outcomes. Awards may be provided for winning outcomes, such as monetary payments (or representations thereof, such as award of credits), prizes or the like. As is well known in the art, the number of winning outcomes may vary dependent upon the desired payout or winning percentage offered to the players as compared to wagers that are retained by the gaming establishment.

The gaming machine 100 also preferably includes one or more player input devices 108 (such as input buttons, a touch-screen display, joystick, touch-pad or the like) that may be utilized by the player to facilitate game play. Also included in the player input devices 108 is a means for accepting a wager or token representing monetary value. As illustrated in FIG. 1, a coin accepting mechanism 112 may be provided for accepting coins as well as a currency or bill acceptor 114 is provided for accepting cash or paper currency. It is contemplated that other mechanisms may be provided for accepting a wager, such as credit card, ticket readers or input devices whereby a player may have funds paid from a remote account.

In one preferred embodiment, the gaming machine 100 includes a microprocessor or controller (not shown) for controlling the gaming machine, including receiving player input and sending output signals for controlling the various components of the machine 100 (such as generating game information for display by the display 104). The controller may be arranged to receive input such as a bet credit signal when one of a wager button is depressed, and a currency insert signal when a player inserts bills or coins. The controller may be arranged to send signals for determining winning combinations, for causing the coin hopper/dispenser to pay winnings, and to cause a display to display winning amount information. In addition, the controller is preferably arranged to determine if a round of game play has resulted in a win, and if so, the amount to be paid to the player for that win.

In operation, the player may initiate game play by placing a wager. The wager is placed by activating one of the player input devices 108 such as a play one credit button 116 which places a single credit wager or a max bet button 118 which places a maximum wager for that round of game play. The maximum bet is commonly defined as playing or betting an amount comprising a multiple of the value of a single wager up to a predefined upper bet limit or threshold. When the player actuates either the play one credit button 116 or the max bet button 118, a wager in that amount is placed and the player's credit base is decreased by the number of credits wagered. The player's remaining credit base is typically displayed to the player by way of the display device 104. Upon placing a wager, the game may begin automatically or the player may initiate the game by activating another player input device, upon which the gaming machine 100 presents one or more game elements which are used to determine if the player has received a winning combination.

The gaming machine 100 generally includes a means for paying a player any winnings accumulated during game play. When a player wins a game, the player is preferably paid in the form of stored credits, the amount of which is indicated to the player on the display 104. A “cash out” button may be provided for permitting a player to be paid the winnings or redeeming any credits initially paid into the gaming machine 100. The term “cash out” is used herein to define an event initiated by the player wherein the player receives a number of coins or currency that is equivalent to the value of the player's accrued credit base.

Typically when a player cashes out, the player receives either a paper currency voucher or currency in the form of a coin disbursement. If the player decides to receive a coin disbursement, the gaming machine 100 activates a coin hopper or coin handling device (not shown) which physically counts and delivers the proper number of coins to the player. The coin handling device is commonly configured to transport coins from a supply source (hopper or bin filled with coins) to a coin tray 124 or payout receptacle where the player physically receives the coins. The player might also elect to cash out by having a ticket or other media dispensed, such as via a printer 120.

The gaming machine 100 may be configured as a stand-alone device or be in communication with one or more external devices at one or more times. For example, the gaming machine 100 may be configured as a server based device and obtain game code or game outcome information from a remote server. The gaming machine 100 may also communicate with a remote accounting server and/or player tracking server, as is well known in the art. As indicated below, a preferred embodiment of the invention is a bingo game which involves two or more players. In such a game, each player may play the bingo game on a different gaming machine 100. Each gaming machine 100 may communicate with a central server (not shown). The central server may generate game information which is provided to one or more gaming machines which are in communication therewith.

It will be appreciated that the gaming machine and system described and illustrated in FIG. 1 is exemplary of just one environment for a tower light of the invention.

One embodiment of the invention is a tower light for a gaming machine. FIG. 1 illustrates a tower light 200 located at a top of the housing 120 of the gaming machine 100. Of course, the particular location and mounting of the tower light 200 might vary, such as depending upon the configuration of the gaming machine 100. For example, if the gaming machine is equipped with a top box, the tower light may be located at the top of the top box portion of the gaming machine.

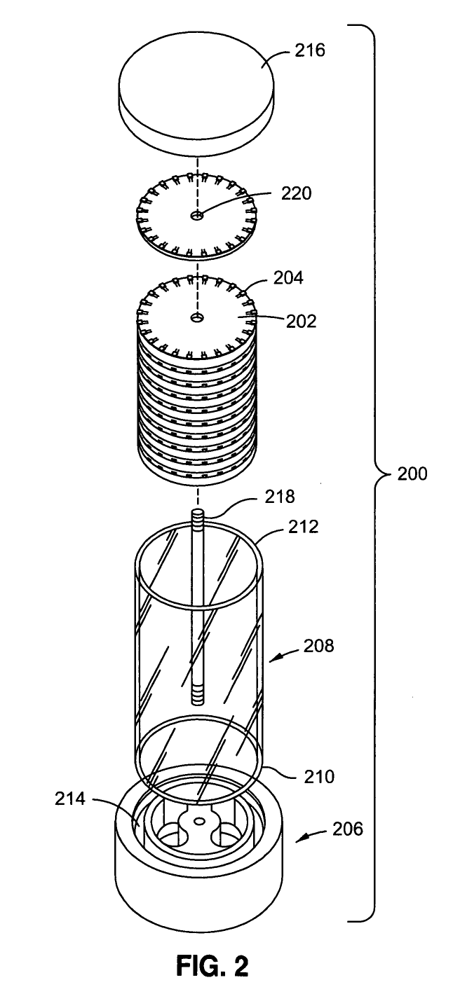

FIG. 2 illustrates a tower light 200 of the invention in greater detail. In one embodiment, the tower light 200 comprises a plurality of lamp mounts 202, each lamp mount having a plurality of light emitting diodes (LEDs) 204 or other light generating/emitting elements mounted thereon (such light generating elements might comprise, for example, high or low intensity LEDs, OLEDs or other light emitting devices now known or later developed). In a preferred embodiment, the LEDs 204 are located at the periphery of each lamp mount 202, so that the LEDs 204 project light outwardly for viewing. Each lamp mount 202 preferably has a plurality of LEDs 204 around the periphery thereof, the LEDs spaced apart from one another in a defined configuration.

In a preferred embodiment, each lamp mount 202 comprises a generally planar printed circuit board. Such a board may comprise a substrate having a plurality of leads or connectors embedded in or located thereon.

As illustrated in FIG. 2, the lamp mounts 202 may be stacked or arranged in a vertically in an array. Preferably, the lamp mounts 202 are oriented so that the LEDs 204 thereon are aligned. In particular, the LEDs 202 are aligned in vertical columns. As a result of the LEDs 204 being located in rows around the lamp mounts 202 and then aligned in vertical columns, a matrix of LEDs aligned in horizontal rows and vertical columns is created. As detailed below, this matrix configuration has numerous advantages.

In one embodiment, each lamp mount 202 has a periphery which is circular in shape. Of course, the mounts 202 might have other configurations/shapes. Preferably, the LEDs encircle the lamp mounts 202 so as to be viewable from all directions (360 degrees).

In a preferred embodiment, the tower light 200 further comprises an enclosure or housing for the mounts 202 and their associated LEDs 204. In one embodiment, the tower light 200 includes a base 206. The base 206 may be constructed from a variety of materials and be various colors or have various attributes such as metallic plating to improve the ornamental appearance thereof. The base 206 may be generally cylindrical in shape. A bottom of the base 206 may be connected to a gaming machine, such as via one or more fasteners.

In one embodiment, the housing or enclosure of the tower light 200 further comprises a globe 208. In a preferred embodiment, the globe 208 comprises a generally a clear (colorless), transparent or translucent body, whereby light emitted by the LEDs 204 can travel through the globe 208 and is visible from the exterior thereof.

As illustrated, the globe 208 may comprise a cylindrical, sleeve-like body having a bottom 210 and a top 212. In this configuration, the body 208 of the globe 208 comprises a cylindrical wall that defines an interior space therein. The bottom 210 of the globe 208 is preferably located in a slot 214 in the base 206 and extends upwardly there from. So connected, the bottom 210 of the globe 208 is generally closed by the base 206 of the tower light 200.

A cap 216 is located at the top 212 of the globe 208. The cap 216 may be constructed of various materials, but is preferably opaque. The cap 216 may include a slot or groove for accepting the top 212 of the globe 208, similar to the base 206.

Preferably, the lamp mounts 202 with their associated LEDs 204 are located inside of the enclosure or housing of the tower light 200. In particular, the lamp mounts 202 are located in the interior of the globe 208, between the base 206 and cap 216.

In one embodiment, a rod 218 may be provided for connecting the various elements of the tower light 200 and providing stability thereto. As illustrated, the rod 218 may connect at one end to the base 206. For example, the end of the rod 218 may be threaded for mating engagement with threads located in a mount of the base 206. The rod 218 may extend generally centrally through the globe 208 and connect at its top end to the cap 216. Similar to the base 206, the cap 216 may connect to the rod 218 via engaging threads.

In order for the rod 218 to extend through the globe 208, the rod 218 passes through the mounts 202. As illustrated in FIG. 2, the lamp mounts 202 may each define a generally centrally located opening or passage 220 through which the rod 218 may extend.

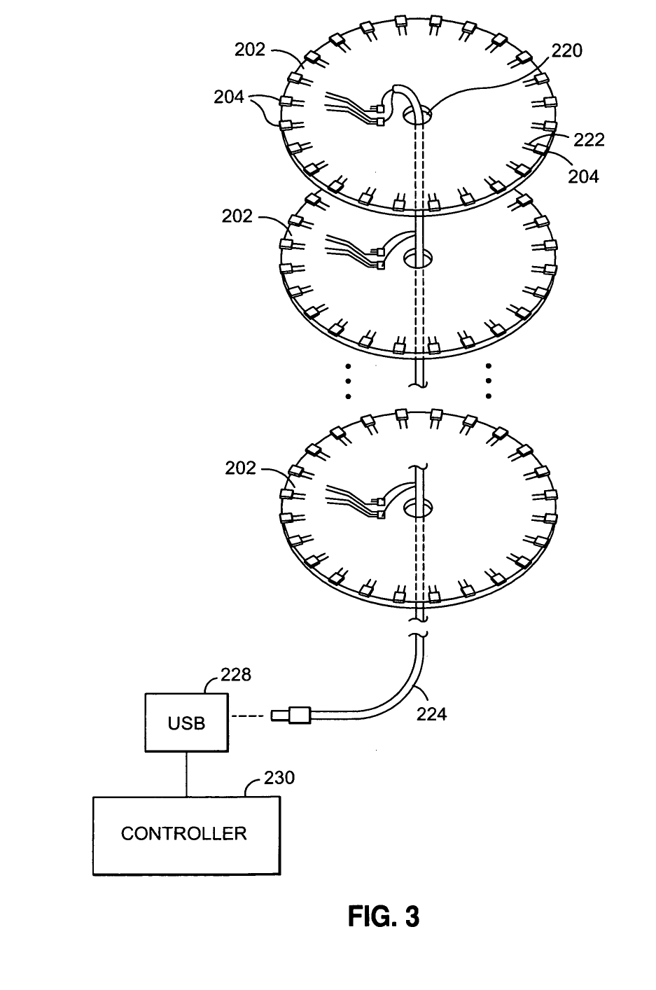

Additional details of the tower light 200 will be described with reference to FIG. 3. As illustrated, in one embodiment, each lamp mount 202 comprises a generally planar circuit board having one or more leads 222. The LEDs 204 may be mounted to a top of the lamp mount 202 so that connectors of each LED connect to the leads of the lamp mount 202.

In one embodiment, the tower light 200 includes at least one connector. The one or more connectors may comprise a power link and/or a communication or control link to the tower light. In one embodiment, at least one connector 224 is provided for providing power to and/or otherwise controlling each lamp mount 202 and its associated LEDs 204. For example, a connector 224 comprising a plurality of wires may extend through the rod 218 or next to the rod 218 through the openings 220 in the lamp mounts 206 (so that the connector is not visible when viewing the tower light from the exterior thereof). The connector 224 may connect to the circuits of the lamp mounts 206.

In one embodiment, the connector 224 is configured to also connect to a controller. In embodiment, the connector 224 may have a USB-type connector 226 at one end for connecting to a USB port 228. This port 226 may be in communication with a controller 228, such as the peripheral controller or master gaming controller of the gaming machine.

In use, as indicated above, the tower light 200 may be associated with a gaming machine. The tower light 200 may be mounted at a top portion of the gaming machine so as to provide the best visibility thereto.

Control signals or instructions may be sent from the controller 230 to cause the LEDs 204 associated with the lamp mounts 202 to illuminate. In one embodiment, each LED 204 associated with each lamp mount 202 can be individually controlled. In this manner, each LED 204 can be caused to turn on or off at certain times. By controlling the LEDs 204, various light patterns or patterns of illumination may be generated. Such light patterns may be used to convey gaming machine state information. For example, in the event of a gaming machine malfunction, the controller 230 may cause all of the LEDs 204 to turn on an off at predetermined intervals, thus creating a “blinking” effect. Other light patterns might be used to convey information to players. For example, the LEDs 204 might be used to generate light which appears as letters (such as spelling words), numbers, or which otherwise creates pleasing patterns.

In one embodiment, the LEDs 204 are multi-color, capable of emitting or generating light in more than one color. Thus, in one embodiment, the LEDs may be controlled to emit light in various colors as part of the above conveyance of information. For example, the LEDs might be caused to “blink” in red to denote a game malfunction, and be configured to emit red, white and blue light in sequence as part of a gaming machine “attract” program.

The invention may have a variety of configurations. In one embodiment, each lamp mount 202 may have an associated processor or controller for processing control instructions received from the external controller. In another embodiment, the tower light 200 may have one or more processors or controllers for such a purpose.

The LEDs may be configured to emit light in various colors. For example, the LEDs may all be configured to emit white light, may be configured to emit different colors of lights (for example, all LEDs associated with each particular lamp mount may be configured to emit a particular color light, and the LEDs of different lamp mounts may be configured to emit different colors of light), and/or the LEDs may each be configured to emit two or more different colors of light.

The number of LEDs associated with each lamp mount may vary. Similarly, the number of lamp mounts may vary. In embodiment, there may be 10 lamp mounts with associated LEDs. However, there may be a greater or lesser number, but preferably there are a sufficient number of lamp mounts and associated LEDs to provide a dense matrix of light emitting elements sufficient to present information.

The size of the tower light and its shape may vary. As indicated, in a preferred embodiment, the tower light is generally cylindrical in shape. In that configuration, the lamp mounts preferably have a circular shape, as does the globe. However, the tower light could have other shapes, such as square, triangular or the like.

Preferably, lamp mounts and globe are sized so that the LEDs are located near the interior of the globe. In this manner, light emitted by the LEDs is effectively transmitted through the globe to the exterior of the tower light.

The configuration of the housing of the tower light may vary. For example, portions of the housing might be molded together (such as the cap and globe) or be connected or assembled in other manners than that described above. Further, the housing might comprise additional or other components.

The tower light can be controlled in various manners. For example, the tower light may be hard wired to the gaming machine controller (or a back plane thereof or the like), or may utilize other connectors (Ethernet, parallel, RS-232 or the like). Also, the tower light may be provided with separate pathways of electrical power and control. For example, in one embodiment, the tower light may be controlled wirelessly with control instructions, but have a dedicated power connection.

While the tower light has particular applicability to a gaming machine, it might be used with other devices or for other purposes.

The tower light of the invention has numerous advantages over the prior art. First, most prior art tower lights merely have globes having colored sections which are back-lit, such as a globe with a bottom blue section, a middle white section and a top red section. These tower lights can only display blue, white or red in the sections thereof which are illuminated. It is not possible, however, for such a tower light to convey text, numbers or the like, or to change the color of the various sections thereof.

Other tower lights have been configured with LEDs. However, these tower lights may simply have a top portion and a bottom portion with scattered LEDs. In this configuration, each half of the tower light can be configured to illuminate its LEDs, again simply illuminating portions of the tower light.

One advantage of the invention is a tower light having a plurality of stacked lamp mounts having associated individually controllable LEDs. The LEDs are arranged so that they are aligned in rows and columns forming a matrix. In the configuration of the invention, each LED is individually controllable, permitting discrete illumination of individual areas, rather than just top or bottom portions (for example, LEDs on either side of a bottom portion of the tower light may be illuminated in accordance with the present invention, while LEDs there between are not).

Further, the individual control of the LEDs and their arrangement into a square matrix or array permits the LEDs to be selectively illuminated to produce images of letters, numbers or the like. This is provides significant advantages over the prior art where the tower light can only be illuminated in general areas. For example, the tower light of the present invention could be configured to display a scrolling message like “J-A-C-K-P-O-T” or a variety of other messages, images or animation, which prior art devices are not capable of producing.

Another advantage of the invention is that the LEDs are arranged around the circular periphery of the tower light, rather than merely in a vertical plane facing in one direction. In this manner, information can be provided from all sides of the tower light, and different information may be displayed by different areas around the tower light.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A tower light for a gaming machine comprising:
a plurality of printed circuit boards, each circuit board having a generally circular periphery;
a plurality of LEDs associated with each circuit board, said LEDs located at the periphery of each circuit board and configured to emit light outwardly from its associated circuit board, said LEDs spaced around said periphery of each circuit board; and
said plurality of printed of circuit boards stacked vertically, said circuit boards oriented so that said LEDs associated with each circuit board are arranged into aligned columns.

2. The tower light in accordance with claim 1 further comprising a base and a globe.

3. The tower light in accordance with claim 1 wherein said plurality of printed circuit boards are located in said globe.

4. The tower light in accordance with claim 1 wherein said LEDs are capable of emitting light in at least two different colors.

5. The tower light in accordance with claim 1 wherein each LED is independently controllable.

6. The tower light in accordance with claim 1 wherein each printed circuit board has an associated controller configured to control the LEDs associated therewith.

7. A gaming machine comprising:
a gaming machine housing having a top;
at least one display device supported by said gaming machine housing;
a wager accepting device;
a gaming controller configured to display wagering game information to said at least one display; and
a tower light located at said top of said gaming machine housing, said tower light comprising:
a tower light housing;
a plurality of printed circuit boards located in said tower light housing, each circuit board having a generally circular periphery;
a plurality of LEDs associated with each circuit board, said LEDs located at the periphery of each circuit board and configured to emit light outwardly from its associated circuit board, said LEDs spaced around said periphery of each circuit board; and
said plurality of printed of circuit boards stacked vertically, said circuit boards oriented so that said LEDs associated with each circuit board are arranged into aligned columns;
said tower light controlled by said gaming controller of said gaming machine.

8. The gaming machine in accordance with claim 7 wherein said tower light housing comprises a base, a globe and a cap, said globe positioned between said base and said cap and said globe being substantially transparent.

9. The gaming machine in accordance with claim 7 wherein said LEDs are capable of emitting light in at least two different colors.

10. The gaming machine in accordance with claim 7 wherein each LED is independently controllable.

11. The gaming machine in accordance with claim 7 wherein each printed circuit board has an associated controller configured to control the LEDs associated therewith.

12. The gaming machine in accordance with claim 7 wherein said tower light housing further comprises a rod extending through said printed circuit boards.

13. The gaming machine in accordance with claim 12 wherein said rod extends between a base and a cap of said tower light housing.

14. The gaming machine in accordance with claim 7 wherein said tower light is in control communication with said gaming machine controller by at least one connection.

15. The gaming machine in accordance with claim 7 wherein said tower light comprises at least 10 of said printed circuit boards.
